(19) United States
(12) Patent Application Publication
(10) Pub. No.: US 2019/0293605 A1
(43) Pub. Date: Sep. 26, 2019

(54) SENSOR HEAD FOR EDDY CURRENT SENSORS

(71) Applicant: COMMISSARIAT A L'ENERGIE ATOMIQUE ET AUX ENERGIES ALTERNATIVES, PARIS (FR)

(72) Inventors: Jean-Marc DECITRE, MARCOUSSIS (FR); Frédéric NOZAIS, MONTIGNY-LE-BRETONNEUX (FR)

(21) Appl. No.: 16/347,801

(22) PCT Filed: Oct. 31, 2017
(86) PCT No.: PCT/EP2017/077908

§ 371 Date: May 6, 2019

(30) Foreign Application Priority Data
Nov. 10, 2016 (FR) 1660910

(51) Int. Cl. G01N 27/90

(52) U.S. Cl. CPC G01N 27/9033; G01N 27/902

(57) ABSTRACT

A test head for eddy-current sensors used in non-destructive testing, which has a high robustness to wear is provided. The test head includes a substrate having at least one element for emitting/receiving electromagnetic field and an external face able to move over the surface of a structure to be inspected, and it is such that the external face is covered with a metal foil.

### FIELD OF THE INVENTION

The invention relates to the field of non-destructive testing with eddy currents of conductive materials, and in particular relates to a test head for eddy-current sensors.

### PRIOR ART

Non-destructive testing (NDT) techniques employing eddy currents (ECs) use the electromagnetic property of eddy currents to detect, in conductive materials to be inspected, defects such as notches, cracks or corrosion. The structures to be inspected are not necessarily planar, such as aeronautical or nuclear metal parts.

NDT with eddy currents is carried out via a sensor comprising a test head that generally includes at least one circuit having an emission function, which is supplied with AC current allowing a local electromagnetic field to be generated, and at least one receiver that is sensitive to this electromagnetic field. The electromagnetic receiver often consists of a receiver coil (and optionally several connected together, for example differentially) across the terminals of which an electromotive force of same frequency as that of the AC supply current is induced. The receiver may also be a Hall-effect sensor or even a magnetoresistance (MR) sensor. The latter family of sensors in particular contains anisotropic magnetoresistance (AMR) sensors, giant magnetoresistance (GMR) sensors, tunnel-effect magnetoresistance (TMR) sensors, and giant magnetoimpedance (GMI) sensors.

According to standard AFNOR NF EN 1330-5, October 1998, an eddy-current transducer is a physical device including exciting elements and receiving elements. In the rest of the description, the term EC sensor designates such an eddy-current transducer and may encompass contact probes or other types of probes for inspecting tubes, whether these contact probes or other types of probes are rigid or flexible. The arrangement and geometric shape of the emitting or receiving elements (emitting/receiving (E/R) elements) is called a “pattern”. A pattern may be made up of separate elements having emitting and receiving functions, of elements grouping together E/R functions, or of elements having one emitting function for a plurality of receivers.

When the test head of a non-destructive eddy-current test sensor is placed in the vicinity of a structure to be inspected or is moved over the surface of such a structure, the emitting circuit is supplied with a sinusoidal signal. An electromagnetic field of same frequency is then emitted into the air and into the structure to be inspected. Across the terminals of the receiving coil, an induced electromagnetic force results, this electromagnetic force being due, on the one hand, to the coupling between the emitting circuit and the receiving coil and, on the other hand, to the magnetic field radiated by the currents induced in the structure (eddy currents).

In case of presence of a non-uniformity in the inspected material (typically a crack or a local variation in the properties of the material), the flow of the induced currents is modified. The magnetic-field receiver measures the magnetic field resulting from this modification of the path of the induced currents.

With ECs, the sensitivity of the measurement (or, in other words, the signal-to-noise ratio) increases as the distance between the emitting and receiving elements of the EC test head and the material to be inspected decreases. In addition, during the movement of the test head over the material, this distance (called the gap) must be as constant as possible in order to prevent noise from appearing in the measurements. This often leads the test head to be moved in contact over the surface to be inspected.

The rubbing undergone by the external face of the test head in contact with the surface of the tested parts leads to premature wear of the head, which corrupts the measurements. Moreover, a tested surface may contain countervailing imperfections able to degrade the external face of the test head.

From an industrial point of view, a sensor may be considered to be a consumable. As soon as unsatisfactory operation of a pattern of the sensor is observed, and which generally is tested just before its use on a reference part, the sensor is replaced. Certain sensor models allow the test head, which is detachable, to be replaced. This increases the cost of the testing procedure.

Moreover, it is desired for a sensor to allow, from an industrial point of view, integral inspection to be carried out with the same sensor of a set of parts or by default of at least one large part such as the inspection of an airplane wing.

In a certain number of publications, such as the patents mentioned below, the external face of the test head may be covered with a layer.

U.S. Pat. No. 7,012,425 B2 by Shoji presents an eddy-current sensor (eddy-current probe) in which the emitting coil consists of an emitting layer covered with an insulating layer.

In U.S. Pat. No. 6,563,307 B2 by Trantow et al. which describes an eddy-current sensor, a protective layer preferably made of Teflon7 polytetrafluoroethylene is adhesively bonded to the emitting layer.

However, the purpose of the added layer, which is chosen for its low coefficient of friction, is to make it easier for the probe to slide.

U.S. Pat. No. 6,670,808 B2 by Nath et al. describes an eddy-current sensor that is housed in a protective casing made of stainless steel, but the active face remains in direct contact with the surface to be inspected.

Thus, the aforementioned approaches do not address the problem of wear of the external face of a test head for an eddy-current sensor.

There is thus a need for a suitable solution that allows the lifetime of eddy-current sensors to be increased, in particular with respect to wear of the test head. The present invention meets this need.

### SUMMARY OF THE INVENTION

One objective of the present invention is to provide a device allowing the robustness to wear of the test heads of the sensors used in non-destructive testing (NDT) with eddy currents (ECs).

Generally, the device of the invention consists of a test head able to move over a structure to be inspected and the external face of which making contact with the surface of the structure is covered with a metal foil.

Advantageously, the device of the invention may be applied to test heads of multielement flexible EC sensors.

To obtain the sought-after results, an eddy-current test head that comprises a substrate having at least one element for emitting/receiving (E/R) electromagnetic field and an external face able to move over the surface of a structure to be inspected is provided, the test head being characterized in that the external face is covered with an unapertured metal foil.

In one preferred embodiment, the metal foil is a stainless-steel foil. Alternatively, the metal foil may be an aluminum foil or a foil made of titanium. Advantageously, the metal foil is anodized in order to increase its hardness and/or to decrease its electrical conductivity. The metal foil may be a layer of a thickness comprised in a range extending from a few microns to a few hundred microns. The metal foil may be adhesively bonded to or deposited directly on the external face of the test head or of the substrate.

According to one implementation, the element for emitting/receiving electromagnetic field is etched into the substrate in the form of a spiraled coil. The substrate may comprise an array of coils in which the coils are spaced apart by a predefined inter-coil pitch.

In one embodiment, the metal foil has an apertured structure comprising holes or notches. The holes or the notches may be spaced apart by an inter-hole or inter-notch pitch smaller than the inter-coil pitch.

According to one variant embodiment, the metal foil is located facing the E/R element. In another variant, the metal foil is located outside of the E/R element.

In one implementation, the metal foil is a serpentine and comprises means for measuring the resistance of the serpentine. In another implementation, the substrate is a flexible substrate of a thickness comprised in a range extending from about ten μm to a few hundred μm.

According to one embodiment, the E/R element or electrical connection tracks are etched into the external face of the substrate and comprises an insulating layer between the external face of the substrate and the metal foil. In one variant, the metal foil is adhesively bonded to the insulating layer.

In one variant of implementation, the test head may comprise a system for paying metal foil in/out, which is able to cover the external face of the test head or the insulating layer with metal foil during its movement over the surface of the inspected structure. The system for paying in/out is able to deliver metal foil with insulating layer, the insulating layer being located on the side of the substrate.

The invention also covers a non-destructive eddy-current test sensor equipped with a test head according to any one of the claimed variants. The test head may further comprise a layer made of compressible material under the polyimide film.

The invention also covers a process for manufacturing an eddy-current test head that comprises steps for obtaining a substrate having at least one element for emitting/receiving electromagnetic field and an external face able to move over the surface of a structure to be inspected. The claimed process is characterized in that it comprises a step of covering the external face with a layer made of metal foil. The process may be applied to the obtainment of a test head according to any one of the claimed variants.

### DESCRIPTION OF THE FIGURES

Various aspects and advantages of the invention will become apparent on reading the description of one preferred but nonlimiting implementation of the invention, with reference to the following figures:

FIG. 1 schematically illustrates a cross-sectional view of a test head according to one embodiment of the invention;

FIGS. 2a to 2c schematically illustrate variant embodiments of the external surface of a test head according to the invention;

FIG. 3 illustrates various embodiments of metal foil used in the test head of the invention; and

FIG. 4 schematically illustrates a cross-sectional view of a test head according to one variant embodiment of the invention using a spool for paying out metal foil.

### DETAILED DESCRIPTION OF THE INVENTION

The general principle of the invention consists in covering, with a metal foil, the external face of a test head for eddy-current NDT sensor.

Because of the use commonly made of metal foils, those skilled in the art could assume that placing a metal foil on the front face of a test head would drastically decrease the sensitivity of the probe, in particular at the working frequencies commonly used in the detection of small defects of a few hundred microns (μm).

Specifically, the various known uses of metal foils show that such foils are chosen to form electromagnetic shielding. This reinforces the idea that using such a material on the front face of an EC sensor would make the sensor unusable.

However, contrary to this preconceived idea, the inventors have produced a test head equipped with a metal foil on its front face that has an acceptable performance level (in which the loss of amplitude induced by the stainless-steel foil is compatible with the detection of the targeted defects) while protecting the test head from wear. Thus, experimentally with a foil of 20 μm thickness, the lifetime of the external face of the test head increases in order to allow a movement over 40 km and of as far as 70 km, the value depending on the pressure exerted on the test head.

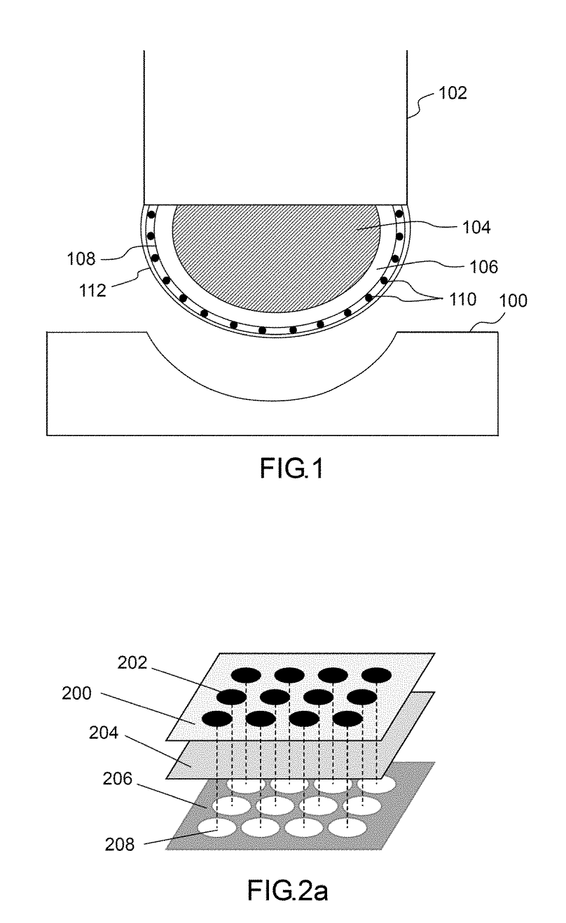

FIG. 1 schematically illustrates a cross-sectional view of a test head able to inspect a part 100, according to one embodiment of the invention. For the sake of clarity of the description, but without limiting it to the described elements, the part to be inspected is presented as having a surface of concave shape over which the test head must move. However, the test head of the present invention is suitable for inspecting any type of planar or nonplanar structure, and indeed tubular structures. Variants in the shape of the test head may be produced depending on the nature of the part to be inspected, without changing the principles of the invention.

In particular, in one preferred embodiment, the test head is designed to equip multielement flexible eddy-current NDT sensors. Advantageously, a flexible sensor allows surfaces of complex 2.5D surfaces, such as cylindrical surfaces, troughs, grooves, inter alia, to be inspected or even structures the shape of which varies to a certain extent to be inspected.

The flexible character of the sensor is obtained by etching, into a very thin substrate 108, a plurality of emitting and receiving E/R elements (sensor array). In one embodiment, the E/R elements are spiral-shaped planar coils made of copper of small diameter, of about 1 mm. Such coils may be used with a sensor working frequency comprised in a range extending from 1 to 10 MHz.

Other forms of coils may be produced, for example receiving elements may be coils of horizontal axis in the thickness of the substrate, or have a rectangular shape or even be GMR receivers.

In other variants, the coils may be of larger diameter, of about 4 mm allowing the detection of surface defects of millimeter-sized length, at an operating frequency ranging from 200 kHz to 10 MHz.

The substrate 108 is a very thin polyimide film, of a thickness comprised in a range extending from about ten μm to a few hundred μm, typically from 12.5 μm to 500 μm. The substrate may be made of Kapton (developed by the company DuPont of Nemours) or polyetheretherketone designated by the acronym PEEK or epoxy.

The multielement character of a sensor is obtained by duplicating many times a given pattern over the flexible substrate 108, forming a multielement array 110. In one particular embodiment, the patterns may be arranged staggered. In order to detect very small surface defects (of about 100 to 400 μm in length), and whatever their position with respect to the patterns of a sensor, the arrayed patterns form a high-density matrix array of emitting/receiving elements.

The test head comes at the end of a mechanical holder or rod 102 from which it may be detachable. Although not shown in FIG. 1, the sensor comprises an electronic circuit that allows the signals resulting from eddy currents to be processed and that may optionally be integrated into the mechanical holder.

In non-destructive eddy-current testing, the sensors have a very high sensitivity to gap, i.e. to the distance between the external face of the test head and the surface to be inspected. A variation in gap during the acquisition of the signals, even if only very slight, of a few tens of μm, leads to substantial variations in the EC signals, this limiting the signal-to-noise ratio and possibly leading to artefacts. To mitigate this effect, in one preferred implementation of the invention, a thickness of compressible material 106 is fastened under the substrate 108 and bears against a rigid counter-form 104. The compressible material (a foam) allows a force to be exerted on all of the substrate in order to ensure a good contact with the part 100 to be tested. The distance between the external face of the test head and the surface to be inspected remains almost constant, excepting vibrations during the movement of the test head, which vibrations are however limited by the fact that the area of the bearing surface is very large.

In one preferred embodiment, a layer consisting of a metal foil 112 covers the entirety of the external face of the test head. Such as schematically illustrated in FIG. 1, the metal foil 112 directly covers all of the layer formed by the substrate 108.

Preferably, the metal foil is a stainless-steel foil. Such a foil has the advantage of having a low conductivity and may be non-magnetic or not very magnetic, so that losses in the foil are limited. In addition, such foils are easily found on the market in several very thin thicknesses, because they are used in mechanics to form spacers of calibrated thickness, and are therefore of perfectly uniform thickness.

In one variant embodiment, the metal foil is an aluminum foil or a foil made of titanium, titanium being depositable on Kapton and having a low conductivity.

Aluminum, which has a higher electrical conductivity, may receive, just like titanium, an anodization treatment.

Advantageously, the metal foil may have received a treatment, such as an anodization, allowing the hardness of the material to be increased, and/or its electrical conductivity to be decreased.

The metal foil forms a layer of a thickness comprised in a range extending from a few microns to a few hundred microns. It may be adhesively bonded to or deposited directly on the substrate or to/on the last external layer forming the stack of layers of the test head.

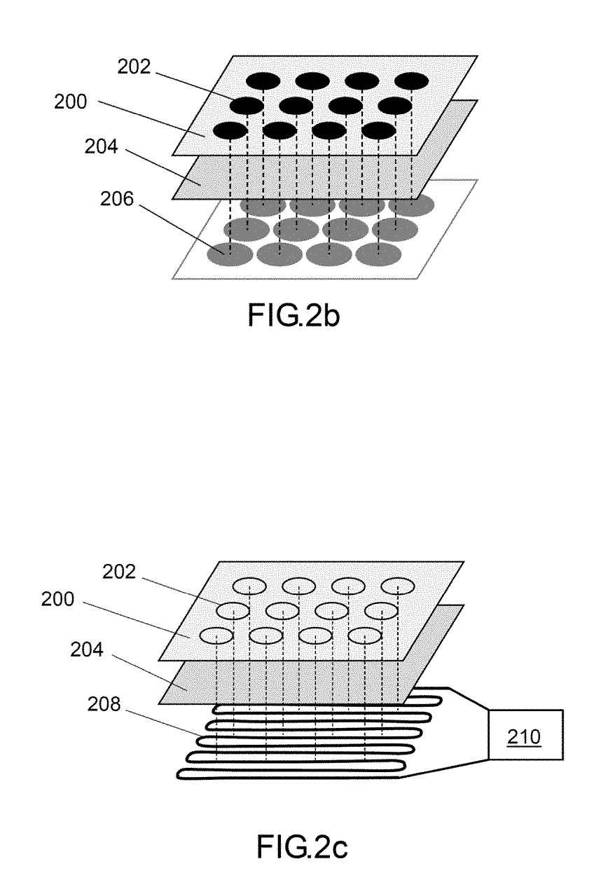

FIGS. 2a to 2c schematically illustrate variant embodiments of the external surface with metal foil of a test head according to the invention. For the sake of simplicity, the figures show, via planar 3D views, variants of stacks of a metal foil 206 on a substrate 200 comprising a plurality of patterns 202. In the shown example embodiments, the patterns are arranged so as to form a high-density array of E/R elements allowing defects to be detected. The patterns may have a spacing with a minimum pitch, which may be constant in a ‘y’ direction that allows, during movement of the test head in an ‘x’ direction perpendicular to ‘y’, an EC map of the eddy currents of the scanned surface to be obtained. In one particular implementation, the number of patterns may be 128.

The pitch of the patterns may not be regular and may be different between the planar ‘x’ and ‘y’ directions.

In FIGS. 2a to 2c, the layer of metal foil 206 has what is referred to as an apertured structure. Advantageously, an apertured metal foil allows eddy currents in the foil (which create attenuation) and therefore attenuation of the magnetic fields in the foil to be limited.

In FIG. 2a, the foil 206 has through-holes 208 in locations corresponding to the sites of the patterns 202 of the substrate 200. The metal foil is located only between the sites of the patterns. The thickness of foil beyond the patterns allows the substrate to be protected without too greatly affecting signal loss.

Those skilled in the art will apply any variant to produce various apertured foils having holes of specific diameter and inter-hole pitch, able to be very much smaller than those of the patterns of the substrate.

In particular, the metal foil may contain notches or striations or be a mesh of wires such as illustrated in the examples (302, 304, 306, 308) of FIG. 3.

Optionally, for variant embodiments in which the patterns or electrical connection tracks are etched into the surface of the external face of the substrate, an intermediate insulating layer 204 is placed between the substrate 200 and the metal foil 206 in order to avoid short-circuiting the turns of the coils of the E/R elements or tracks. The insulating layer may be formed by an insulating adhesive between the substrate and the metal foil or by a standard finishing varnish on the substrate or be a standard finishing coverlay of minimum thickness (50 μm or less) or even be formed by another insulating material (film of insulating adhesive, self-adhesive Kapton, etc.).

In the example of FIG. 2b, the metal foil 206 is apertured and has foil zones in locations corresponding to the sites of the patterns 202 of the substrate 200. Such a configuration may be advantageous in cases where a bulge appears level with the elements, a copper bulge for example, requiring a protection in this location.

Optionally, an insulating layer 204 may be intermediate between the substrate and the metal foil.

In the example of FIG. 2c, the metal foil 208 is apertured and has a serpentine geometry. In this variant, a device (210) allows the resistance of the serpentine to be regularly measured in order to detect, via variations in the value of the resistance, wear of the external face of the test head, or even interruption of the serpentine as a result of substantial damage.

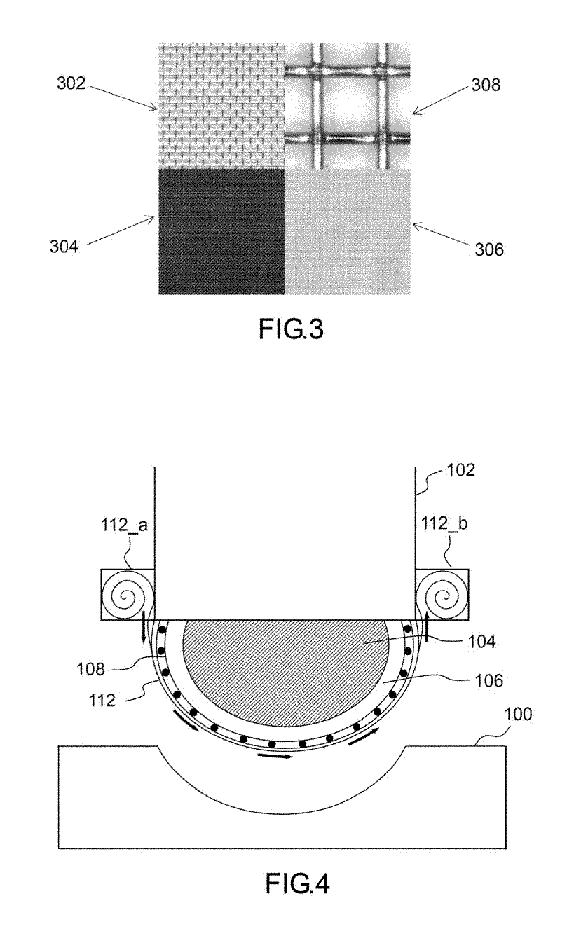

FIG. 4 schematically illustrates a cross-sectional view of a test head according to one variant embodiment of the invention using a spool for paying out metal foil. Elements that are identical to those described with reference to FIG. 1 have been given the same references. In this embodiment, the test head is equipped with a paying-out system (112a) allowing new metal foil to be delivered, and a paying-in system (112b) allowing worn metal foil to be collected. The paying-out spool is dynamically emptied and filled as the foil is used, in order to regularly protect the external face of the test head with new foil.

In one variant embodiment, the paying-out spool allows a material composed of a stack of a metal film with an insulating layer to be delivered, such that the material is applied to the external face of the test head with the insulating layer placed on the side of the substrate.

The movement of the foil (indicated by arrows in the figure) may be achieved via a slow continuous rotation of the rollers of the paying-in and paying-out spools while the sensor is being scanned. The foil may be moved incrementally, depending on the pressure to be exerted on the test head, or even depending on the geometry of the inspected part.

The metal foil delivered by the paying-out spool may be a metal foil having a uniform and unapertured structure (such as the foil of FIG. 1) or a metal foil having an apertured structure (such as the foils of FIGS. 2 and 3).

Thus, the present description illustrates a preferred implementation of the invention, but is nonlimiting. An example, and a concrete application, were chosen in order to allow the principles of the invention to be clearly understood, but this example is in no way exhaustive and necessarily allows those skilled in the art to make modifications and come up with variants of implementation that preserve the same principles.

1. An eddy-current test head comprising a substrate having at least one element for emitting/receiving electromagnetic field and an external face able to move over the surface of a structure to be inspected, the test head being wherein said external face is covered with a metal foil.

2. The test head as claimed in claim 1, wherein the metal foil is a stainless-steel foil.

3. The test head as claimed in claim 1, wherein the metal foil is an aluminum foil or a foil made of titanium.

4. The test head as claimed in claim 3, wherein the metal foil is anodized in order to increase its hardness and/or to decrease its electrical conductivity.

5. The test head as claimed in claim 1, wherein the metal foil is a layer of a thickness comprised in a range extending from a few microns to a few hundred microns.

6. The test head as claimed in claim 1, wherein said at least one element for emitting/receiving electromagnetic field is etched into the substrate in the form of a spiraled coil.

7. The test head as claimed in claim 6, wherein the substrate comprises an array of coils, the coils being spaced apart by a predefined inter-coil pitch.

8. The test head as claimed in claim 1, wherein the metal foil has an apertured structure comprising holes or notches.

9. The test head as claimed in claim 8, wherein the substrate comprises an array of coils, the coils being spaced apart by a predefined inter-coil pitch, and wherein the holes or notches are spaced apart by an inter-hole or inter-notch pitch smaller than the inter-coil pitch.

10. The test head as claimed in claim 1, wherein the metal foil is located facing said at least one emitting/receiving element.

11. The test head as claimed in claim 1, wherein the metal foil is located outside of said at least one emitting/receiving element.

12. The test head as claimed in claim 1, wherein the metal foil is a serpentine and comprises means for measuring the resistance of the serpentine.

13. The test head as claimed in claim 1, wherein the substrate is a flexible substrate of a thickness comprised in a range extending from about ten μm to a few hundred μm.

14. The test head as claimed in claim 1, wherein the metal foil is adhesively bonded to said external face of the test head.

15. The test head as claimed in claim 1, wherein the metal foil is deposited directly on the external face of the substrate.

16. The test head as claimed in claim 1, wherein said at least one element for emitting/receiving electromagnetic field is etched into the external face of the substrate and further comprising an insulating layer between said external face of the substrate and the metal foil.

17. The test head as claimed in claim 16, wherein the metal foil is adhesively bonded to the insulating layer.

18. The test head as claimed in claim 1, further comprising a system for paying metal foil in/out, able to cover the external face of the test head with metal foil during its movement over the surface of the inspected structure.

19. The test head as claimed in claim 16, further comprising a system for paying metal foil in/out, able to cover the insulating layer with metal foil during its movement over the surface of the inspected structure.

20. The test head as claimed in claim 18, wherein the system for paying in/out is able to deliver metal foil with insulating layer, the insulating layer being located on the side of the substrate.

21. A non-destructive eddy-current test sensor comprising a test head as claimed in claim 1.

22. The sensor as claimed in claim 21, wherein the test head furthermore comprises a layer made of compressible material under the polyimide film.

23. A process for manufacturing an eddy-current test head comprising steps for obtaining a substrate having at least one element for emitting/receiving electromagnetic field and an external face able to move over the surface of a structure to be inspected, the process comprising a step of covering said external face with a layer made of metal foil.

24. The process as claimed in claim 23, wherein the metal foil is a stainless steel foil.
